(19) United States
(12) Patent Application Publication
(10) Pub. No.: US 2023/0406700 A1
(43) Pub. Date: Dec. 21, 2023

(54) Processes and Systems for Upgrading a Hydrocarbon-Containing Feed

(71) Applicant: ExxonMobil Chemical Patents Inc., Baytown, TX (US)

(72) Inventors: Mohsen N. Harandi, Calgary (CA); Paul F. Keusenkothen, Houston, TX (US); Ying Liu, Houston, TX (US)

(21) Appl. No.: 18/254,039

(22) PCT Filed: Nov. 17, 2021
(86) PCT No.: PCT/US2021/059698

§ 371 Date: May 23, 2023

Related U.S. Application Data
(60) Provisional application No. 63/126,156, filed on Dec. 16, 2020.

(51) Int. Cl. C01B 3/12; C01B 3/50; C01B 32/50; C09K 8/594; C10J 3/46; C10B 55/10; B01D 53/26

(52) U.S. Cl. CPC C01B 3/12; C01B 3/506; C01B 32/50; C09K 8/594; C10J 3/46; C10B 55/10; B01D 53/265; C01B 2203/0294; C01B 2203/0822; C01B 2203/0883; C01B 2203/046; C01B 2203/0495; C01B 2203/0485; B01D 2257/80; B01D 2257/404; B01D 2257/302

(57) ABSTRACT

Processes for converting a hydrocarbon-containing feed by pyrolysis and gasification/combustion. The hydrocarbon-containing feed and heated particles can be fed into a pyrolysis zone and contacted therein to effect pyrolysis of the hydrocarbons and produce a pyrolysis effluent. A gaseous stream rich in olefins and a particle stream rich in particles that include coke disposed thereon can be obtained from the pyrolysis effluent. A CO₂-rich stream that includes, on a dry basis, CO₂ at a concentration ≥90 vol %, based on the total volume of the CO₂-rich stream, can be obtained from the gasification/combustion gas mixture.

### CROSS-REFERENCE TO RELATED APPLICATION

This application claims priority to and the benefit of U.S. Provisional Application No. 63/126,156 having a filing date of Dec. 16, 2020, the disclosure of which is incorporated herein by reference in its entirety.

### FIELD

This disclosure relates to processes and systems for upgrading a hydrocarbon-containing feed. In particular, this disclosure relates to processes and systems for converting a hydrocarbon-containing feed by pyrolysis and gasification/combustion to produce various products, e.g., olefins.

### BACKGROUND

Steam cracking, also referred to as pyrolysis, has long been used to crack various hydrocarbon-containing feeds into olefins, preferably light olefins such as ethylene, propylene, and butenes. Conventional steam cracking utilizes a pyrolysis furnace (“steam cracker”) that has two main sections: a convection section and a radiant section. The hydrocarbon-containing feed typically enters the convection section of the furnace as a liquid (except for light feedstocks that typically enter as a vapor) where the feedstock is typically heated and vaporized by indirect heat exchange with a hot flue gas from the radiant section and by direct contact with steam. The vaporized feedstock and steam mixture is fed into the radiant section where the cracking takes place. The resulting pyrolysis effluent, including olefins, leaves the pyrolysis furnace for further downstream processing, including quenching.

Conventional pyrolysis furnaces do not have the flexibility to process residues, crudes, or many residues, crude gas oils, or naphthas that are contaminated with non-volatile components. Non-volatile components, if present in the feed, typically cause fouling within the radiant section of the pyrolysis furnace. An external vaporization drum or flash drum has been implemented to separate vaporized hydrocarbons from liquid hydrocarbons to address the fouling problems in the pyrolysis furnace. The vaporized hydrocarbons are then cracked in the pyrolysis furnace and the liquid hydrocarbons that include nonvolatile components are removed and used as fuel. The liquid hydrocarbons, however, still contain a substantial quantity of hydrocarbons which, if converted into higher-value lighter hydrocarbons such as olefins via cracking, would bring substantial additional value to the crude oil feed. Thus, for decades the petrochemical industry has been trying to take advantage of relatively low-cost heavy crude oil to make substantial quantities of valuable chemicals such as olefins. The large amount of non-volatiles in the low-cost heavy crude oil, however, requires extensive and expensive processing.

There is a need, therefore, for improved processes and systems for upgrading hydrocarbon-containing feeds to produce valuable chemical products such as olefins. This disclosure satisfies this and other needs.

### SUMMARY

The present inventors have devised a process for converting a hydrocarbon-containing feed by pyrolysis. In some embodiments, the process for converting a hydrocarbon-containing feed by pyrolysis, can include (I) feeding the hydrocarbon-containing feed and heated particles into a pyrolysis zone and (II) contacting the hydrocarbon-containing feed with the heated particles in the pyrolysis zone to effect pyrolysis of at least a portion of the hydrocarbon-containing feed to produce a pyrolysis zone effluent that can include olefins and the particles, where coke is formed on the surface of the particles. The process can also include (III) obtaining from the pyrolysis zone effluent a first gaseous stream rich in the olefins and a first particle stream rich in the particles. The process can also include (IV) feeding at least a portion of the first particle stream, an oxidant stream, and an optional steam stream into a gasification/combustion zone and (V) contacting the first particle stream, the oxidant stream, and the optional steam stream within the gasification/combustion zone to effect gasification/combustion of at least a portion of the coke disposed on the surface of the particles to produce a gasification/combustion zone effluent comprising regenerated particles and a gasification/combustion gas mixture comprising CO and/or CO₂. The oxidant stream can include molecular oxygen. The process can also include (VI) obtaining from the gasification/combustion zone effluent a second gaseous stream rich in the gasification/combustion gas mixture and a second particle stream rich in the regenerated particles and (VII) feeding at least a portion of the second particle stream into the pyrolysis zone as at least a portion of the heated particles fed into the pyrolysis zone in step (I). The process can also include (VIII) obtaining a CO₂-rich stream from the gasification/combustion gas mixture. The CO₂-rich stream, on a dry basis, can include CO₂ at a concentration of ≥90 vol %, based on the total volume of the CO₂-rich stream.

### BRIEF DESCRIPTION OF THE DRAWINGS

FIG. 1 depicts an illustrative system for converting a hydrocarbon-containing feed by pyrolysis and primarily gasification, according to one or more embodiments described.

FIG. 2 depicts another illustrative system for converting a hydrocarbon-containing feed by pyrolysis and primarily combustion, according to one or more embodiments described.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

In this disclosure, a process is described as comprising at least one “step.” It should be understood that each step is an action or operation that may be carried out once or multiple times in the process, in a continuous or discontinuous fashion. Unless specified to the contrary or the context clearly indicates otherwise, multiple steps in a process may be conducted sequentially in the order as they are listed, with or without overlapping with one or more other steps, or in any other order, as the case may be. In addition, one or more or even all steps may be conducted simultaneously with regard to the same or different batch of material. For example, in a continuous process, while a first step in a process is being conducted with respect to a raw material just fed into the beginning of the process, a second step may be carried out simultaneously with respect to an intermediate material resulting from treating the raw materials fed into the process at an earlier time in the first step. Preferably, the steps are conducted in the order described.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Certain embodiments and features are described herein using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

As used herein, the indefinite article “a” or “an” shall mean “at least one” unless specified to the contrary or the context clearly indicates otherwise. Thus, embodiments using “a pyrolysis reactor” include embodiments where one, two or more pyrolysis reactors are used, unless specified to the contrary or the context clearly indicates that only one pyrolysis reactor is used.

The term “hydrocarbon” as used herein means (i) any compound consisting of hydrogen and carbon atoms or (ii) any mixture of two or more such compounds in (i). The term “Cn hydrocarbon,” where n is a positive integer, means (i) any hydrocarbon compound comprising carbon atom(s) in its molecule at the total number of n, or (ii) any mixture of two or more such hydrocarbon compounds in (i). Thus, a C2 hydrocarbon can be ethane, ethylene, acetylene, or mixtures of at least two of these compounds at any proportion. A “Cm to Cn hydrocarbon” or “Cm−Cn hydrocarbon,” where m and n are positive integers and m<n, means any of Cm, Cm+1, Cm+2, Cn−1, Cn hydrocarbons, or any mixtures of two or more thereof. Thus, a “C2 to C3 hydrocarbon” or “C2-C3 hydrocarbon” can be any of ethane, ethylene, acetylene, propane, propene, propyne, propadiene, cyclopropane, and any mixtures of two or more thereof at any proportion between and among the components. A “saturated C2-C3 hydrocarbon” can be ethane, propane, cyclopropane, or any mixture thereof of two or more thereof at any proportion. A “Cn+ hydrocarbon” means (i) any hydrocarbon compound comprising carbon atom(s) in its molecule at the total number of at least n, or (ii) any mixture of two or more such hydrocarbon compounds in (i). A “Cn− hydrocarbon” means (i) any hydrocarbon compound comprising carbon atoms in its molecule at the total number of at most n, or (ii) any mixture of two or more such hydrocarbon compounds in (i). A “Cm hydrocarbon stream” means a hydrocarbon stream consisting essentially of Cm hydrocarbon(s). A “Cm−Cn hydrocarbon stream” means a hydrocarbon stream consisting essentially of Cm−Cn hydrocarbon(s).

The term “non-volatile components” as used herein refers to the fraction of a petroleum feed having a nominal boiling point of at least 590° C., as measured by ASTM D6352-15 or D-2887-18. Non-volatiles include coke precursors, which are large, condensable molecules that condense in the vapor and then form coke during pyrolysis of the petroleum feed.

The term “crude” as used herein means whole crude oil as it flows from a wellhead, a production field facility, a transportation facility, or other initial field processing facility, optionally including crude that has been processed by a step of desalting, treating, and/or other steps as may be necessary to render it acceptable for conventional distillation in a refinery. Crude, as used herein, is presumed to contain resid. The term “crude fraction”, as used herein, means a hydrocarbon fraction obtained via the fractionation of crude.

The term “resid” as used herein refers to a bottoms cut of a crude distillation process that contains non-volatile components. Resids are complex mixtures of heavy petroleum compounds otherwise known in the art as residuum or residual. Atmospheric resid is the bottoms product produced from atmospheric distillation of crude where a typical endpoint of the heaviest distilled product is nominally 343° C., and is referred to as 343° C. resid. The term “nominally”, as used herein, means that reasonable experts may disagree on the exact cut point for these terms, but by no more than +/−55.6° C. preferably no more than +/−27.8° C. Vacuum resid is the bottoms product from a distillation column operated under vacuum where the heaviest distilled product can be nominally 566° C., and is referred to as 566° C. resid.

The term “water” refers to the chemical compound having formula H₂O and can be in a solid phase (ice), a liquid phase, or a gaseous phase (steam), depending, at least in part, on the particular process conditions, e.g., temperature and pressure.

The term “olefin product” as used herein means a product that includes an alkene, preferably a product consisting essentially of one or more alkenes. An olefin product in the meaning of this disclosure can be, for example, an ethylene stream, a propylene stream, a butylene stream, an ethylene/propylene mixture stream, and the like.

The term “aromatic” as used herein is to be understood in accordance with its art-recognized scope which includes alkyl substituted and unsubstituted mono- and polynuclear compounds.

The term “consisting essentially of” as used herein means the composition, feed, effluent, product, or other stream includes a given component at a concentration of at least 60 wt %, preferably at least 70 wt %, more preferably at least 80 wt %, more preferably at least 90 wt %, still more preferably at least 95 wt %, based on the total weight of the composition, feed, effluent, product, or other stream in question.

The term “rich” when used in phrases such as “X-rich” or “rich in X” means, with respect to an outgoing stream obtained from a device, that the stream comprises material X at a concentration higher than in the feed material fed to the same device from which the stream is derived.

The term “lean” when used in phrases such as “X-lean” or “lean in X” means, with respect to an outgoing stream obtained from a device, that the stream comprises material X at a concentration lower than in the feed material fed to the same device from which the stream is derived.

The term “on a dry basis”, as used herein, refers to a product, e.g., a CO₂-rich stream or a shifted gas stream, without water.

The terms “channel” and “line” are used interchangeably and mean any conduit configured or adapted for feeding, flowing, and/or discharging a gas, a liquid, and/or a fluidized solids feed into the conduit, through the conduit, and/or out of the conduit, respectively. For example, a composition can be fed into the conduit, flow through the conduit, and/or discharge from the conduit to move the composition from a first location to a second location. Suitable conduits can be or can include, but are not limited to, pipes, hoses, ducts, tubes, and the like.

As used herein, “wt %” means percentage by weight, “vol %” means percentage by volume, “mol %” means percentage by mole, “ppm” means parts per million, and “ppm wt” and “wppm” are used interchangeably to mean parts per million on a weight basis. All concentrations herein are expressed on the basis of the total amount of the composition in question, unless specified otherwise. Thus, the concentrations of the various components of the “hydrocarbon-containing feed” are expressed based on the total weight of the hydrocarbon-containing feed. All ranges expressed herein should include both end points as two specific embodiments unless specified or indicated to the contrary.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6th Edition, by F. Albert Cotton et al. (John Wiley & Sons, Inc., 1999).

The hydrocarbon-containing feed or simply the hydrocarbon feed can be, can include, or can be derived from petroleum, plastic material, natural gas condensate, landfill gas (LFG), biogas, coal, biomass, bio-based oils, rubber, or any mixture thereof. In some examples, the hydrocarbon-containing feed can include a non-volatile component. In some examples, the petroleum can be or can include any crude or any mixture thereof, any crude fraction or any mixture thereof, or any mixture of any crude with any crude fraction. A typical crude includes a mixture of hydrocarbons with varying carbon numbers and boiling points. Thus, by using conventional atmospheric distillation and vacuum distillation, one can produce a range of fuel products with varying boiling points, for example, naphtha, gasoline, kerosene, distillate, and tar. It is highly desired, however, to convert the large hydrocarbon molecules contained in the crude into more valuable, lighter products including, but not limited, to ethylene, propylene, butylenes, and the like, which can be further made into more valuable products such as polyethylene, polypropylene, ethylene-propylene copolymers, butyl rubbers, and the like.

The petroleum can be or can include: crude oil, atmospheric resid, vacuum resid, steam cracked gas oil and residue, gas oil, heating oil, hydrocrackate, atmospheric pipestill bottoms, vacuum pipestill streams including bottoms, gas oil condensate, heavy non-virgin hydrocarbon stream from refineries, vacuum gas oil, heavy gas oil, naphtha contaminated with crude, heavy residue, C_{4's}/residue admixture, naphtha/residue admixture, hydrocarbon gases/residue admixture, hydrogen/residue admixture, gas oil/residue admixture, or any mixture thereof. Non-limiting examples of crudes can be, or can include, but are not limited to, Tapis, Murban, Arab Light, Arab Medium, and/or Arab Heavy.

The plastic material can be, or can include, but is not limited to, polyethylene terephthalate (PETE or PET), polyethylene (PE), polypropylene (PP), polyvinyl chloride (PVC), polyvinylidene chloride (PVDC), polystyrene (PS), polycarbonate (PC), polylactic acid (PLA), acrylic (PMMA), acetal (polyoxymethylene, POM), acrylonitrile-butadiene-styrene (ABS), fiberglass, nylon (polyamides, PA), polyester (PES) rayon, polyoxybenzylmethylenglycolanhydride (bakelite), polyurethane (PU), polyepoxide (epoxy), or any mixture thereof. The rubber can be or can include natural rubber, synthetic rubber, or a mixture thereof. The biogas can be produced via anaerobic digestion, e.g., the biogas produced during the anaerobic digestion of sewage. The biobased oil can be or can include oils that can degrade biologically over time. The biobased oil can be degraded via processes of bacterial decomposition and/or by the enzymatic biodegradation of other living organisms such as yeast, protozoans, and/or fungi. Biobased oils can be derived from vegetable oils, e.g., rapeseed oil, castor oil, palm oil, soybean oil, sunflower oil, corn oil, hemp oil, or chemically synthesized esters. The biomass can be or can include, but is not limited to, wood, agricultural residues such as straw, stover, cane trash, and green agricultural wastes, agro-industrial wastes such as sugarcane bagasse and rice husk, animal wastes such as cow manure and poultry litter, industrial waste such as black liquor from paper manufacturing, sewage, municipal solid waste, food processing waste, or any mixture thereof.

If the hydrocarbon-containing feed includes material that is solid at room temperature, e.g., plastic material, biomass, coal, rubber, etc., the solid material can be reduced to any desired particle size via well-known processes. For example, if the hydrocarbon-containing feed includes solid material, the solid material can be ground, crushed, pulverized, other otherwise reduced into particles that have any desired average particle size. In some examples, the solid matter can be reduced to an average particle size that can be submicron or from about 1 μm, about 10 μm or about 50 μm to about 100 μm, about 150 μm, or about 200 μm. For example, the average particle size of the solid material can range from about 75 μm to about 475 μm, from about 125 μm to about 425 μm, or about 175 μm to about 375 μm.

In some embodiments, the hydrocarbon-containing feed can include one or more crude oils or a fraction thereof and one or more plastic materials. In some embodiments, the hydrocarbon-containing feed can include petroleum and one or more plastic materials and the one or more plastic materials can be present in an amount in a range of from 1 wt %, 3 wt %, 5 wt %, 7 wt %, 10 wt %, or 15 wt % to 20 wt %, 25 wt %, 30 wt %, 35 wt %, 40 wt %, or 45 wt %, based on the total weight of the hydrocarbon-containing feed.

The petroleum, e.g., crude oil or fraction thereof, can act as a solvent for the plastic material and cause at least a portion of the plastic material to dissolve in the crude oil or fraction thereof. In some embodiments, at least 30 wt %, at least 40 wt %, at least 50 wt %, at least 60 wt %, at least 70 wt %, at least 80 wt %, at least 90 wt %, or even 100 wt % of the plastic material mixed with the crude oil or fraction thereof can be solubilized in the crude oil or fraction thereof. As such, in some embodiments, when the hydrocarbon-containing feed includes one or more plastic materials, the hydrocarbon-containing feed can be in the form of a solution in which the plastic material is homogeneously dispersed in the crude oil or fraction thereof.

The particles that can be used in the process for converting the hydrocarbon-containing feed by pyrolysis and gasification/combustion can be or can include, but are not limited to, silica, alumina, titania, zirconia, magnesia, pumice, ash, clay, diatomaceous earth, bauxite, spent fluidized catalytic cracker catalyst, or any mixture or combination thereof. In some embodiments, the particles can be or can include a core and at least one transition metal element and/or at least one oxidized transition metal element disposed on and/or in the core. In some embodiments, the core can be or can include, but is not limited to, silica, alumina, titania, zirconia, magnesia, pumice, ash, clay, diatomaceous earth, bauxite, spent fluidized catalytic cracker catalyst, or any mixture or combination thereof. Preferred support materials can be or can include, but are not limited to, Al₂O₃, ZrO₂, SiO₂, and combinations thereof, more preferably, SiO₂, Al₂O₃, or SiO₂/Al₂O₃.

In some embodiments, the transition metal element and/or the oxide thereof can be disposed on and/or within, e.g., within pores, of the core. In some embodiments, the transition metal element and/or the oxide thereof can form a surface layer on the core. The surface layer on the core can be continues or discontinuous. The core and/or the particles that include the at least one transition metal element and/or at least one oxidized transition metal element disposed on and/or in the core can have an average size in a range from 10 micrometers (μm), 15 μm, 25 μm, 50 μm, or 75 μm to 150 μm, 200 μm, 300 μm, 400 μm. The core and/or the particles that include the at least one transition metal element and/or at least one oxidized transition metal element disposed on and/or in the core can have a surface area in a range from 10 m²/g, m²/g, or 100 m²/g to 200 m²/g, 500 m²/g, or 700 m²/g.

In some embodiments, the particles can be, can include, or can otherwise be derived from spent fluid catalytic cracker (“FCC”) catalyst. As such, a significant and highly advantageous use for spent FCC catalyst has been discovered because the processes disclosed herein can significantly extend the useful life of FCC catalyst in upgrading hydrocarbons long after the FCC catalyst is considered to be spent and no longer useful in the fluid catalytic cracking process.

In some embodiments, the particles can include any oxide of a transition metal element capable of converting at least a portion of any molecular hydrogen to water, e.g., via oxidation, combustion, or other mechanism, within the pyrolysis reaction zone. In some embodiments, the transition metal element can be or can include, but is not limited to, titanium, vanadium, chromium, manganese, iron, cobalt, niobium, nickel, molybdenum, tantalum, tungsten, alloys thereof, and mixtures thereof. In some examples, the transition metal element can be or can include vanadium, nickel, an alloy thereof, or a mixture thereof. The amount of optional transition metal element that can be disposed on and/or at least partially within the particles can be in a range from 500 wppm, 750 wppm, 1,000 wppm, 2,500 wppm, 5,000 wppm, or 1 wt % to 2 wt %, 5 wt %, 10 wt %, 15 wt %, 20 wt %, 30 wt %, 40 wt %, or 50 wt %, based on a total weight of the particles. In some embodiments, the amount of optional transition metal element that can be disposed on and/or at least partially within the particles can be at least 1 wt %, at least 2.5 wt %, at least 3 wt %, at least 3.5 wt %, at least 4 wt %, at least 4.5 wt %, at least wt %, or at least 10 wt % up to 15 wt %, 20 wt %, 30 wt %, 40 wt %, or 50 wt %.

### Process for Converting the Hydrocarbon-Containing Feed

The process for converting the hydrocarbon-containing feed by pyrolysis can include feeding the hydrocarbon-containing feed and heated particles into a pyrolysis zone and contacting the hydrocarbon-containing feed with the heated particles in the pyrolysis zone to effect pyrolysis of at least a portion of the hydrocarbon-containing feed to produce a pyrolysis zone effluent that can include olefins and the particles, where coke can be formed on the surface of the particles. In some embodiments, the hydrocarbon-containing feed can include water. In other embodiments, the process can also include optionally feeding a steam stream into the pyrolysis zone in addition to the hydrocarbon-containing feed and the heated particles.

The first pyrolysis zone can be located in any suitable reactor or other process environment capable of operating under the pyrolysis process conditions. In some embodiments, the first pyrolysis zone can be located in short contact time fluid bed. In some embodiments, the first pyrolysis zone can be located in a downflow reactor, an upflow reactor, a counter-current flow reactor, or vortex reactor. In a preferred embodiment, the first pyrolysis zone can be located in a downflow reactor.

The hydrocarbon-containing feed can be contacted with the heated particles in the pyrolysis zone to effect pyrolysis of at least a portion of the hydrocarbon-containing feed. The heated particles can be at a temperature in a range of from 750° C., 800° C., 850° C., 900° C., or 950° C. to 1,050° C., 1,100° C., 1,200° C., 1,300° C., 1,400° C., or 1,500° C. In some embodiments, the heated particles can be at a temperature of at least 800° C., at least 820° C., at least 840° C., at least 850° C., at least 875° C., at least 900° C., at least 950° C., or at least 975° C. to 1,000° C., 1,050° C., 1,100° C., 1,200° C., 1,300° C., or 1,400° C. In some embodiments, the pyrolysis zone effluent can be at a temperature of 800° C., 850° C., 900° C., 925° C., or 950° C. to 975° C., 1,000° C., 1050° C., 1,100° C., or 1,150° C.

The hydrocarbon-containing feed can be contacted with an amount of the particles within the pyrolysis zone sufficient to effect a desired level or degree of pyrolysis of the hydrocarbon-containing feed. In some embodiments, a weight ratio of the particles to the hydrocarbon-containing feed when contacted within the pyrolysis zone can be 5, 10, 12, 15, or to 25, 30, 35, 40, 45, 50, 55, or 60. In some embodiments, the optional steam stream can be introduced or otherwise fed into the pyrolysis zone in an amount sufficient to provide a weight ratio of the steam to the hydrocarbon-containing feed of 0.01:1, 0.05:1, 0.1:1, 0.5:1, or 0.7:1 to 1:1, 2:1, 3:1, 4:1, 5:1, or 6:1.

The hydrocarbon-containing feed can contact the particles within the pyrolysis zone under a vacuum, at atmospheric pressure, or at a pressure greater than atmospheric pressure. In some embodiments, the hydrocarbon-containing feed can contact the particles within the pyrolysis zone under an absolute pressure of 100 kPa, 500 kPa, 1,000 kPa, or 1,500 kPa to 3,000 kPa, 4,000 kPa, 5,000 kPa, 6,000 kPa, or 7,000 kPa. In other embodiments, the hydrocarbon-containing feed can contact the particles within the pyrolysis zone under an absolute pressure of 100 kPa, 150 kPa, 200 kPa, 250 kPa, 300 kPa, or 400 kPa to 450 kPa, 500 kPa, 550 kPa, 600 kPa, 650 kPa, 700 kPa, 750 kPa, 800 kPa, or 840 kPa. In still other embodiments, the hydrocarbon-containing feed can contact the particles within the pyrolysis zone under an absolute pressure of less than 800 kPa, less than 700 kPa, less than 600 kPa, less than 500 kPa, less than 450 kPa, less than 400 kPa, less than 350 kPa, less than 300 kPa, less than 250 kPa, less than 200 kPa, or less than 150 kPa.

In some embodiments, the velocity of the gaseous components within the pyrolysis zone can be in a range of 9 m/s, 20 m/s, 50 m/s, or 75 m/s to 100 m/s, 115 m/s, 130 m/s, 155 m/s, or 175 m/s. In some embodiments, the velocity of the particles within the pyrolysis zone can be up to 3 m/s, 5 m/s, 7 m/s, 10 m/s, 12, m/s, or 15 m/s. In some embodiments, the velocity of the gaseous components within the pyrolysis zone can be at least 15%, at least 20%, at least 25%, at least 30%, at least 35%, at least 40%, at least 45%, or at least 50% greater than a velocity of the particles within the pyrolysis zone.

The hydrocarbon-containing feed can contact the particles within the pyrolysis zone for a residence time of 1 millisecond (ms), 5 ms, 10 ms, 25 ms, 50 ms, 75 ms, or 100 ms to 300 ms, 500 ms, 750 ms, 1,000 ms, 1,250 ms, 1,500 ms, 1,750 ms, or 2,000 ms. In some embodiments, the hydrocarbon-containing feed can contact the particles within the pyrolysis zone for a residence time of 10 ms to 700 ms, 10 ms to 500 ms, 10 ms to 100 ms, 20 ms to 200 ms, 30 ms to 225 ms, 50 ms to 250 ms, 125 ms to 500 ms, 200 ms to 600 ms, or 20 ms to 140 ms. In other embodiments, the hydrocarbon-containing feed can contact the particles within the pyrolysis zone for a residence time of less than 1,000 ms, less than 800 ms, less than 600 ms, less than 400 ms, less than 300 ms, less than 200 ms, less than 150 ms, or less than 100 ms.

As noted above, during contact of the hydrocarbon-containing feed with the particles in the pyrolysis zone, coke can be formed on the surface of the particles. For example, when hydrocarbon-containing feed includes non-volatile components at least a portion of the non-volatile components can deposit, condense, adhere, or otherwise become disposed on the surface of the particles and/or at least partially within the particles, e.g., within pores of the particles, in the form of coke. In some embodiments, the particles in the first pyrolysis zone effluent can include 1 wt %, 3 wt %, 5 wt %, 7 wt %, 10 wt %, or 15 wt % to 20 wt %, 25 wt %, 30 wt %, 35 wt %, 40 wt %, 45 wt %, or 50 wt % of coke, based on a total weight of the particles in the pyrolysis zone effluent.

A pyrolysis zone effluent that can include hydrocarbons, e.g., olefins, and the particles that can include the coke formed thereon can be obtained from the pyrolysis zone. The pyrolysis zone effluent can be fed from the pyrolysis zone into one or more first separation stages configured or adapted to receive the pyrolysis zone effluent and separate a first gaseous stream rich in the hydrocarbons, e.g., olefins, and a second particle stream rich in the particles. The second separation stage can be configured or adapted to discharge the first gaseous stream and the second particle stream therefrom.

In some embodiments, at least a portion of the particles in the pyrolysis zone effluent can optionally be stripped by contacting the particles in the pyrolysis zone effluent with a stripping medium within the first separation stage. For example, the pyrolysis zone effluent can be fed from the pyrolysis zone into the first separation stage, which can be configured or adapted to contact the pyrolysis zone effluent or at least a portion of the particles in the pyrolysis zone effluent with a stripping medium, e.g., a first steam stream, and separate the pyrolysis zone effluent to obtain the first gaseous stream rich in the olefins and rich in the optional stripping medium and the second particle stream rich in the particles. As such, in some embodiments, the first separation stage can also be referred to a stripping vessel. In some embodiments, a residence time of the particles in the pyrolysis zone effluent separated within the first separation stage from the pyrolysis zone effluent can be in a range from 30 seconds, 1 minute, 3 minutes, 5 minutes, or 10 minutes to 15 minutes, 17 minutes, 20 minutes, 25 minutes, or longer before being discharged therefrom as the second particle stream rich in particles. In some embodiments, the optional stripping medium can fed into the first separation stage at a weight ratio of the stripping medium to the pyrolysis zone effluent fed into the first separation stage in a range from 1:1,000, 2:1,000, or 2.5:1,000, or 3:1,000 to 4:1,000, 6:1,000, 8:1,000, or

In some embodiments, the first separation stage can include an inertial separator configured to separate a majority of the particles from the hydrocarbons to produce the first gaseous stream rich in hydrocarbons and the second particle stream rich in the particles. Inertial separators can be configured or adapted to concentrate or collect the particles by changing a direction of motion of the first pyrolysis zone effluent such that the particle trajectories cross over the hydrocarbon gas streamlines and the particles are either concentrated into a small part of the gas flow or are separated by impingement onto a surface. In some embodiments, a suitable inertial separator can include a cyclone. Illustrative cyclones can include, but are not limited to, those disclosed in U.S. Pat. Nos. 7,090,081; 7,309,383; and 9,358,516.

In some embodiments, a residence time within the first separation stage of the hydrocarbons separated from the pyrolysis zone effluent can be less than 1,000 ms, less than 750 ms, less than 500 ms, less than 250 ms, less than 100 ms, less than 75 ms, less than 50 ms, or less than 25 ms. In some embodiments, a residence time within the first separation stage of the hydrocarbons separated from the pyrolysis zone effluent can be in a range from 2 ms, 4 ms, 6 ms, or 8 ms to 10 ms, 12 ms, 14 ms, 16 ms, 18 ms, or 20 ms before being discharged therefrom as the first gaseous stream. In some embodiments, the residence time within the first separation stage of the hydrocarbons separated from the pyrolysis zone effluent can be less than 20 ms, less than 15 ms, less than 10 ms, less than 7 ms, less than 5 ms, or less than 3 ms before being discharged therefrom as the first gaseous stream. The first gaseous stream, upon being discharged from the first separation stage, can be free or substantially free of any particles. In some embodiments, the first gaseous stream discharged from the first separation stage can include less than 25 wt %, less than 20 wt %, less than 15 wt %, less than 12 wt %, less than 10 wt %, less than 8 wt %, less than 6 wt %, less than 5 wt %, less than 3 wt %, or less than 1 wt % of the particles present in the pyrolysis zone effluent.

In some embodiments, a residence time of the hydrocarbons in the first gaseous stream separated from the pyrolysis zone effluent spanning from the initial introduction of the hydrocarbon-containing feed and the heated particles into the pyrolysis zone to the recovery of the first gaseous stream rich in the olefins from the first separation stage can be 5 ms, 10 ms, ms, 50 ms, 75 ms, or 100 ms to 300 ms, 500 ms, 750 ms, 1,000 ms, 1,250 ms, 1,500 ms, 1,750 ms, or 2,000 ms. In other embodiments, the residence time of the hydrocarbons in the first gaseous stream separated from the pyrolysis zone effluent spanning from the initial introduction of the hydrocarbon-containing feed and the heated particles into the pyrolysis zone to the recovery of the first gaseous stream rich in the olefins from the first separation stage can be less than 1,500 ms, less than 1,250 ms, less than 1,000 ms, less than 800 ms, less than 600 ms, less than 400 ms, less than 300 ms, less than 200 ms, less than 150 ms, or less than 100 ms.

At least a portion of the second particle stream, an oxidant stream, optionally a second steam stream, optionally a fuel stream, and/or optionally a diluent stream can be fed into a gasification/combustion zone. The second particle stream, the oxidant stream, and the optional second steam stream, the optional fuel stream, and/or the optional diluent stream can be contacted within the gasification/combustion zone to effect gasification and/or combustion of at least a portion of the coke disposed on the surface of the particles to produce a gasification/combustion zone effluent that can include heated and regenerated particles and a gasification/combustion gas mixture. The reactions that can occur within the gasification/combustion zone can include, but are not limited to, combustion (C+O₂→CO₂; 2H₂+O₂→2H₂O), gasification (C+H₂O→CO+H₂; C+CO₂→2CO); and/or water gas shift reaction (CO+H₂O↔CO₂+H₂). As such, in some embodiments the gasification/combustion zone can be configured to produce primarily a gasification/combustion gas mixture that can include a synthesis gas that can include molecular hydrogen (H₂), carbon monoxide (CO), and carbon dioxide (CO₂). In other embodiments, the gasification/combustion zone can be configured to produce primarily a gasification/combustion gas mixture that can include a flue gas that can include carbon dioxide (CO₂) and water (H₂O) or molecular nitrogen (N₂), carbon dioxide (CO₂) and water (H₂O).

The oxidant stream can be or can include molecular oxygen such as air, oxygen enriched air, oxygen depleted air, or any mixture thereof. In some embodiments, the oxidant stream can be a molecular oxygen containing gas that can have a relatively high molecular nitrogen content. In some embodiments, the oxidant stream can include molecular oxygen and molecular nitrogen, with the molecular nitrogen at a concentration of ≥15 vol %, ≥25 vol %, ≥vol %, ≥60 vol %, ≥70 vol %, ≥80 vol %, or ≥85 vol %, based on the total volume of the oxidant stream. In some embodiments, the oxidant stream can be a molecular oxygen containing gas that can have relatively a low nitrogen content, such as oxygen from an air separation unit. In some embodiments, an oxidant stream that can include 40 vol %, 50 vol %, 60 vol %, 70 vol %, 80 vol %, 90 vol %, 95 vol %, 98 vol % or more of molecular oxygen and a nitrogen rich stream can be separated from air and the oxidant stream that includes 40 vol % or more of molecular oxygen can be introduced into the gasification/combustion zone. In some embodiments, the oxidant stream can include molecular oxygen at a concentration of ≥85 vol %, ≥90 vol %, ≥95 vol %, ≥97 vol %, ≥98 vol %, ≥99 vol %, or ≥99.5 vol % and molecular nitrogen at a concentration of ≤15 vol %, ≤10 vol %≤5 vol %, ≤3 vol %, or ≤1 vol %, based on the total volume of the oxidant stream.

The fuel can be or can include any combustible source of material capable of combusting in the presence of the oxidant stream within the gasification/combustion zone. Suitable fuels can be or can include, but are not limited to, molecular hydrogen, methane, ethane, propane, butane, natural gas, naphtha, gas oil, fuel oil, quench oil, fuel gas such as a mixture of one or more C₁-C₅ hydrocarbons, or any mixture thereof. In some embodiments, the fuel stream can be fed into the gasification/combustion zone and a first portion of the fuel stream can be combusted within the gasification/combustion zone and a second portion of the fuel stream can be converted into molecular hydrogen and carbon monoxide. The diluent can be any essentially inert gas such as carbon dioxide, molecular nitrogen, or a mixture thereof.

The gasification/combustion zone can be operated at a temperature of 1,000° C., 1,050° C., 1,100° C., 1,150° C., 1,200° C., 1,250° C., or 1,300° C. to 1,350° C., 1,400° C., 1,450° C., or 1,500° C. Operating the gasification/combustion zone at such an elevated temperature can produce heated and regenerated particles having a sufficient amount of heat that can be utilized within the pyrolysis zone to effect the pyrolysis of the hydrocarbon-containing feed. The gasification/combustion zone can be operated at a pressure of 100 kPa-absolute, 200 kPa-absolute, 300 kPa-absolute, 400 kPa-absolute, or 500 kPa-absolute to 700 kPa-absolute, 800 kPa-absolute, 900 kPa-absolute, or 1,000 kPa-absolute. In some embodiments, the gasification/combustion zone can be operated at a temperature of at least 1,000° C., e.g., 1,200° C. to 1,500° C., and at a pressure of ≤800 kPa-absolute. In other embodiments, the gasification/combustion zone can be operated at a temperature of at least 1,000° C., e.g., 1,200° C. to 1,500° C., and at a pressure of ≥800 kPa-absolute, such as 800 kPa-absolute to 7,000 kPa-absolute.

In some embodiments, the amount of oxidant introduced into the gasification/combustion zone can be reduced or limited to a substoichiometric amount that would be needed for complete combustion of all the coke disposed on the particles and, if present, all of the hydrocarbon fuel introduced into the gasification/combustion zone. The amount of oxidant introduced into the gasification/combustion zone can be sufficient to combust a sufficient amount of the coke and, if present, optionally combust a sufficient amount of the hydrocarbon fuel to provide heat for the gasification/combustion zone and at least a portion of the heat within the pyrolysis zone via the heated and regenerated particles recycled thereto. In some embodiments, the amount of oxidant introduced into the gasification zone can be 30% to 90% or 50% to 70% of the amount of oxidant that would be required for complete combustion of all the coke formed on the surface of the particles and, if present, all of the fuel introduced into the gasification/combustion zone.

In some embodiments, when the second particle stream rich in particles includes coke disposed on and/or at least partially in the particles, at least a portion of the coke can be gasified in the gasification/combustion zone to produce the gasification/combustion gas mixture that can include molecular hydrogen, carbon monoxide, and carbon dioxide. In other embodiments, when the second particle stream rich in particles includes coke disposed on and/or at least partially in the particles, at least a portion of the coke can be combusted within the gasification/combustion zone to produce the gasification/combustion gas mixture that can include a flue gas that can include molecular nitrogen, carbon dioxide, and water. In still other embodiments, when the second particle stream rich in particles includes coke disposed on and/or at least partially in the particles, at least a portion of the coke can be gasified and at least a portion of the coke can be combusted within the gasification/combustion zone to produce the gasification/combustion gas mixture.

The heated and regenerated particles in the gasification/combustion zone effluent can include less coke as compared to the particles in the second particle stream rich in the particles or can be free of any coke. In some embodiments, the particles in the heated and regenerated particles in the gasification/combustion zone effluent can include less than 5 wt %, less than 4 wt %, less than 3 wt %, less than 2 wt %, less than 1 wt %, less than 0.5 wt %, or less than 0.1 wt % of coke.

The gasification/combustion zone effluent can be separated into a third particle stream that can be rich in the heated and regenerated particles and a second gaseous stream rich in the gasification/combustion gas mixture. In some embodiments, the gasification/combustion zone effluent can be introduced or otherwise fed into a third separation stage that can be configured to separate a majority of the heated and regenerated particles from the gaseous components to produce the second gaseous stream and the third particle stream rich in the heated and regenerated particles. In some embodiments, the third separation stage can be or can include one or more inertial separators similar to or the same as those described above with regard to the first separation stage.

At least a portion of the third particle stream rich in the regenerated particles can be recycled or otherwise fed into the pyrolysis zone as at least a portion of the heated particles. In some embodiments, a portion of the second gaseous stream rich in the gasification/combustion gas mixture can be fed as the diluent stream into the gasification/combustion zone. In some embodiments, the second gaseous stream can include molecular hydrogen

(H₂) at a concentration of from 8 vol %, 10 vol %, or 12 vol % to 20 vol %, 25 vol %, or 28 vol %, carbon monoxide at a concentration of from 10 vol %, 15 vol % or 20 vol % to 25 vol %, 30 vol %, or 35 vol %, and carbon dioxide at a concentration of ≥3 vol %, ≥4 vol %, or ≥5 vol %, based on the total volume of the second gaseous stream. In some embodiments, the second gaseous stream, on a volume basis, can include a greater amount of molecular nitrogen than a combined amount of molecular hydrogen, carbon monoxide, and carbon dioxide.

In some embodiments, when the particles include the oxide of a transition metal element capable of oxidizing molecular hydrogen within the first pyrolysis zone, at least a portion of the transition metal element disposed on and/or in the particles in the pyrolysis zone effluent can be at a reduced state as compared to the transition metal element in the particles fed into the pyrolysis zone. Without wishing to be bound by theory, it is believed that when the particles include the optional oxide of the transition metal element capable of oxidizing molecular hydrogen within the pyrolysis zone, the oxide of the transition metal element can do so via one or more processes or mechanisms. Regardless of the overall mechanism, the oxidized transition metal element can facilitate the conversion of molecular hydrogen to water and in doing so the oxidation state of the oxide of the transition metal element can be reduced. For example, if the transition metal element is vanadium, the oxide of vanadium on the fluidized particles fed into the pyrolysis reaction zone can be at an oxidation state of +5 (for example) and at least a portion of the oxide of vanadium on the fluidized particles in the pyrolysis effluent can be at an oxidation state of +4, +3, or +2. Without wishing to be bound by theory, it is also believed that one or more of the oxides of one or more transition metal elements may be capable of being reduced from an oxidized state all the way to the metallic state.

Additionally, the oxide of the transition metal element, if present, can favor the conversion, e.g., oxidation and/or combustion, of hydrogen over the oxidation and/or combustion of hydrocarbons, e.g., olefins, in the pyrolysis zone. In some examples, the oxide of the transition metal element can favor the conversion of hydrogen over the conversion of hydrocarbons at a rate of 2:1, 3:1, 4:1, 5:1, 6:1, or 7:1 to 8:1, 9:1, 10:1, or 11:1.

In some embodiments, heat can be indirectly transferred from the second gaseous stream that can be rich in the gasification/combustion gas mixture to a cooling medium to produce a cooled second gaseous stream that can include water in the liquid phase. At least a portion of the water and, if present, optionally at least a portion of any regenerated particles and/or, if present, optionally at least a portion of any hydrogen sulfide can be separated from the cooled second gaseous stream to produce a purified second gaseous stream. At least a portion of the purified second gaseous stream can be compressed to produce a compressed second gaseous stream. In some embodiments, a portion of the compressed second gaseous stream can be fed to into the gasification/combustion zone as the optional diluent stream.

When the oxidant stream includes molecular nitrogen at a concentration of ≥15 vol %, based on the total volume of the oxidant stream, the gasification/combustion zone can be operated under primarily as a gasification zone such that the second gaseous stream includes molecular hydrogen, carbon monoxide, carbon dioxide, and molecular nitrogen. In this embodiment, at least a portion of the second gaseous stream can be reacted with additional steam under shifting conditions to produce a shifted gas stream. The shifted gas stream, on a dry basis, can include carbon dioxide at a concentration of ≥20 vol %, ≥25 vol %, or ≥30 vol %, based on the total volume of the shifted gas stream. The shifted gas stream can be separated to provide a carbon dioxide-rich stream and a carbon dioxide-lean gas stream that can include molecular hydrogen and molecular nitrogen. In some embodiments, at least a portion of the carbon dioxide-lean gas stream can be combusted to produce heat, with a very low emission of carbon dioxide. In some embodiments, a fuel can be combined with the carbon dioxide-lean gas stream to produce an adjusted gas stream and at least a portion of the adjusted gas stream can be combusted to produce heat. The fuel can be or can include, but is not limited to, methane, ethane, propane, butane, or a mixture thereof. In this embodiment, a portion of the second gaseous stream can be introduced into the gasification/combustion zone as the diluent stream.

When the oxidant stream includes molecular nitrogen at a concentration of ≥15 vol %, based on the total volume of the oxidant stream, the gasification/combustion zone can be operated primarily as a gasification zone such that the second gaseous stream includes molecular hydrogen, carbon monoxide, carbon dioxide, and molecular nitrogen. In this embodiment, heat can be indirectly transferred from the second gaseous stream to a cooling medium to produce a cooled second gaseous stream that can include water in the liquid phase. At least a portion of the water and, if present, optionally at least a portion of any regenerated particles and/or, if present, optionally at least a portion of any hydrogen sulfide can be separated from the cooled second gaseous stream to produce a purified second gaseous stream. Any convenient method for removal of hydrogen sulfide can be used. In some examples, the hydrogen sulfide can be removed in an adsorbent stage, such as a Flexsorb® sulfur removal stage. In some embodiments, the sulfur removal stage can be selective for the removal of sulfur, e.g., hydrogen sulfide, while reducing or minimizing removal of carbon dioxide. In some embodiments, the sulfur removal systems and processes disclosed in WO Publication No. 2009/017811. At least a portion of the purified second gaseous stream can be compressed to produce a compressed second gaseous stream. In this embodiment, at least a portion of the compressed second gaseous stream can be reacted with additional steam under shifting conditions to produce a shifted gas stream. In some embodiments, a portion of the compressed second gaseous stream can be introduced into the gasification/combustion zone as at least a portion of the optional diluent stream. The shifted gas stream can be separated to provide a carbon dioxide-rich stream and a carbon dioxide-lean gas stream that can include molecular hydrogen and molecular nitrogen. Any convenient type of carbon dioxide separation can be used, such as cryogenic separation, membrane separation, absorption separation, and/or adsorption (including swing adsorption).

When the oxidant stream includes molecular oxygen at a concentration of ≥95 vol % and molecular nitrogen at a concentration ≤5 vol %, based on the total volume of the oxidant stream, the gasification/combustion zone is preferably operated primarily as a combustion zone such that the second gaseous stream includes a flue gas that includes carbon dioxide and water. In this embodiment, heat can be indirectly transferred from the second gaseous stream to a cooling medium to produce a cooled second gaseous stream that can include water. At least a portion of the water can be separated from the cooled second gaseous stream to produce a carbon dioxide-rich stream, on a dry basis, that includes carbon dioxide at a concentration of ≥vol %, based on the total volume of the carbon dioxide-rich stream. In this embodiment, if the second gaseous stream includes any catalyst fines or fine particles, if the second gaseous stream includes any sulfur oxides, e.g., sulfur dioxide (SO₂), and/or if the second gaseous stream includes any nitrogen oxides (NOx), at least a portion of any one or more of the fine particles, sulfur dioxide, and/or nitrogen oxide can optionally be removed or otherwise abated from the second gaseous stream.

If nitrogen oxides are present in the second gaseous stream and it is preferred to remove at least a portion of the nitrogen oxides, the second gaseous stream can be introduced into a DeNOx reactor to remove at least a portion of any nitrogen oxides. The DeNOx reactor can include one or more catalysts that can contact the second gaseous stream in the presence of molecular hydrogen under conditions sufficient to convert at least a portion of any nitrogen oxides to ammonia. In some embodiments, the catalyst can be or can include, but is not limited to, nickel-based sulfided catalysts, copper-based catalysts, and the like. In other embodiments, selective catalytic reduction can be used to convert nitrogen oxides into molecular nitrogen and water. A reductant such as anhydrous ammonia, aqueous ammonia, or a urea solution can be added to the second gaseous stream to drive the reaction toward completion. Suitable catalysts for in the selective catalytic reduction process can be or can include, but are not limited to, one or more oxides of a base metal such as vanadium, molybdenum, and/or tungsten disposed on a support such as titanium oxide, one or more zeolites, one or more precious metals, and the like. Other nitrogen oxide removal processes and systems can also include those disclosed in U.S. Pat. Nos. 3,900,554; 4,104,361; 4,164,546; 4,235,704; and 4,254,616. Processes and systems for removing SOx are well-known and can include those described in U.S. Pat. Nos. 3,873,670; 4,001,375; 4,071,436; 4,059,418; 4,254,616; 5,120,517; 5,741,469; 5,728,358; and WO Publication No. 2009/017811.

When the oxidant stream includes molecular oxygen at a concentration of ≥95 vol % and molecular nitrogen at a concentration ≤5 vol %, based on the total volume of the oxidant stream, the gasification/combustion zone can be operated primarily as a combustion zone such that the second gaseous stream includes a flue gas that includes molecular nitrogen, carbon dioxide, and water. The second gaseous stream or the second gaseous stream in which at least a portion of any fine particles, sulfur dioxide, and/or nitrogen oxides has been abated can be subjected to dehydration to produce the carbon dioxide-rich stream. The dehydration of the second gaseous stream can be carried out using any convenient system. In some embodiments, the dehydration of the second gaseous stream can be carried out according to the processes and systems disclosed in U.S. Patent Application Publication No. 2012/0060690. In some embodiments all acid gases containing CO₂, SOx and NOx can be sequestered together. In some embodiments, when the oxidant stream includes molecular nitrogen at a concentration of ≥15 vol %, based on the total volume of the oxidant stream, and the shifted gas stream is separated to provide the carbon dioxide-rich stream and the carbon dioxide-lean gas stream that can include molecular hydrogen and molecular nitrogen, the carbon dioxide-rich stream can optionally be further subjected to dehydration to produce a dehydrated carbon dioxide-rich stream which can be used for enhanced oil recovery, food grade CO₂ after conventional purification, dry ice or sequestration.

In some embodiments, at least a portion of the carbon dioxide-rich stream that can be obtained from the gasification/combustion gas mixture can be utilized, upon optional compression, in an enhanced oil recovery process. In some embodiments, at least a portion of the carbon dioxide-rich stream that can be obtained from the gasification/combustion gas mixture can be sequestered, e.g., in a subterranean formation. In some embodiments, at least a portion of the carbon dioxide-rich stream that can be obtained from gasification combustion gas mixture can be converted into another compound. In some embodiments, at least a portion of the carbon dioxide-rich stream that can be obtained from gasification combustion gas mixture can be introduced into a carbon dioxide pipeline.

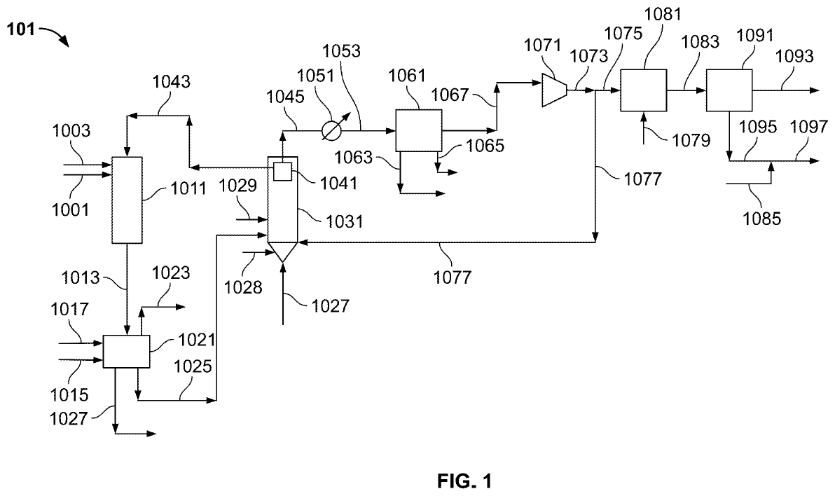

FIG. 1 depicts an illustrative system 101 for converting a hydrocarbon-containing feed in line 1001 by pyrolysis and primarily gasification, according to one or more embodiments. The system 101 can include one or more pyrolysis zones 1011, one or more first separation stages 1021, one or more gasification/combustion zones 1031, one or more second separation stages 1041, one or more heat exchange stages 1051, and one or more third separation stages 1061. The system 101 can also include one or more compression stages 1071, one or more shifting stages 1081, and one or more fourth separation stages 1091. In some embodiments, the shifting stage 1081 can preferably include a relatively high temperature shift followed by a relatively lower temperature shift reaction to enhance the conversion of carbon monoxide. The hydrocarbon-containing feed via line 1001 and heated particles via line 1043 can be fed into the pyrolysis zone 1011. In some embodiments, an optional steam stream via line 1003 can also be fed into the pyrolysis zone 1011. In some embodiments, if the optional steam stream via line 1003 is introduced into the pyrolysis zone 1011, the optional steam stream can be introduced upstream of the hydrocarbon-containing feed.

The hydrocarbon-containing feed and optionally the steam stream can contact the heated particles within the pyrolysis zone 1011 to effect pyrolysis of at least a portion of the hydrocarbons in the hydrocarbon-containing feed to produce a pyrolysis zone effluent. The pyrolysis zone effluent can include olefins and particles having coke deposited or otherwise formed on a surface thereof. The pyrolysis zone effluent via line 1013 can be obtained from the pyrolysis zone 1011 and fed into the first separation stage 1021. Optionally a stripping steam stream via line 1015 can be introduced into the second separation stage 1021 to improve the separation of gaseous components that can be entrained in the particles.

A first gaseous stream rich in the olefins via line 1023 and a second particle stream rich in the particles via line 1025 can be discharged or otherwise obtained from the second separation stage 1021. In some embodiments, a portion of the particles from the pyrolysis zone effluent can be recovered via line 1027 from the second separation stage 1021 and removed from the system 101. In some embodiments, it can be desirable to remove some of the particles via line 1027 and replace the removed particles with fresh or make-up particles via line 1017. For example, should the particles accumulate too much of a transition metal on the surface thereof, some of the particles can be removed while make-up particles can be introduced via line 1017 into the system 101.

The second particle stream via line 1025, an oxidant stream via line 1027, an optional steam stream via line 1028, an optional fuel stream via line 1029, and/or an optional diluent stream via line 1077 can be introduced or otherwise fed into the gasification/combustion zone 1031. The particles having the coke formed on the surface thereof, oxidant, optional steam, optional fuel, and/or optional diluent can be contacted within the gasification/combustion zone 1031 to effect gasification and/or combustion of at least a portion of the coke disposed on the surface of the particles to produce a gasification/combustion zone effluent. The gasification/combustion zone effluent can include heated and regenerated particles and a gasification/combustion gas mixture that can include molecular hydrogen, carbon monoxide, carbon dioxide, molecular nitrogen, water, or any mixture thereof. In some embodiments, the gasification/combustion gas mixture can include molecular hydrogen, carbon monoxide, and carbon dioxide. In other embodiments, the gasification/combustion gas mixture can include a flue gas that can include nitrogen, carbon dioxide, and water.

In some embodiments, the gasification/combustion zone effluent can be fed into the second separation stage 1041 and a third particle stream that can include the heated and regenerated particles via line 1043 and a second gaseous stream rich in the gasification/combustion gas mixture via line 1045 can be recovered or otherwise obtained therefrom. The second separation stage 1041, as shown, can be disposed within the gasification/combustion zone 1031. However, the second separation stage 1041 can also be located outside the gasification/combustion zone 1031. The third separation stage 1031 can be an inertial separator or other separator as described above. In some embodiments, at least a portion of the third particle stream via line 1043 can be fed into the pyrolysis zone 1011 as at least a portion of the heated particles introduced thereto.

In some embodiments, the second gaseous stream via line 1045 can be introduced into the heat exchange stage 1051 to produce a cooled or quenched second gaseous stream via line 1053. The cooled second gaseous stream in line 1053 can be rich in the gasification/combustion zone mixture and can include condensed or liquid water. The second gaseous stream in line 1045 can be indirectly cooled by transferring heat from the second gaseous stream to a cooling medium, by direct contact with a cooling medium, or a combination thereof. In some embodiments, particles entrained in the second gaseous stream in line 1045 can also be present in the condensed water. The cooled second gaseous stream via line 1053 can be introduced or otherwise fed into the third separation stage 1061 to separate at least a portion of the condensed water and, if present, particles via line 1063.

The third separation stage 1061 can include multiple separation stages. In some embodiments, the third separation stage 1061, in addition to removing the water and, if present, particles, can also include a hydrogen sulfide removal stage. As such, hydrogen sulfide, if present, can also be removed via line 1065 from the cooled second gaseous stream in the third separation stage 1061. A purified second gaseous steam via line 1067 can be recovered or otherwise obtained from the third separation stage 1061.

In some embodiments, the purified second gaseous stream via line 1067 can be introduced or otherwise fed into the compression stage 1071 to produce a compressed second gaseous stream via line 1073. In some embodiments, all or a portion of the compressed second gaseous stream in line 1073 can be introduced via line 1075 into the shifting stage 1081. In some embodiments, a portion of the compressed second gaseous stream in line 1073 can be introduced or otherwise fed via line 1077 to the gasification/combustion zone 1031 as the optional diluent stream.

The compressed second gaseous stream fed via line 1075 and a steam stream via line 1079 can be fed into the shifting stage 1081. At least a portion of the compressed second gaseous stream can react with the steam stream under shifting conditions to produce a shifted gas stream. The shifted gas stream can include carbon dioxide, on a dry basis, at a concentration of ≥20 vol %, based on the total volume of the shifted gas stream. The shifted gas stream can be recovered or otherwise obtained via line 1083 from the shifting stage 1081. The shifted gas stream can be fed via line 1083 into the fourth separation stage 1091 from which can be recovered or otherwise obtained a carbon dioxide-rich stream via line 1093 and a carbon dioxide-lean stream via line 1095. The carbon dioxide-lean stream in line 1095 can include molecular hydrogen and molecular nitrogen.

The carbon dioxide-rich stream via line 1093 can be utilized, upon optional compression, in an enhanced oil recovery process; sequestered, e.g., in a subterranean formation; converted into another compound; and/or introduced into a carbon dioxide pipeline. At least a portion of the carbon dioxide-lean stream in line 1095 can be combusted to produce heat. In some embodiments, a fuel via line 1085 can be combined with the carbon dioxide-lean stream in line 1095 to produce an adjusted gas stream via line 1097 and at least a portion of the adjusted gas stream in line 1097 can be combusted to produce heat. The fuel can be or can include, but is not limited to, methane, ethane, propane, butane, or a mixture thereof.

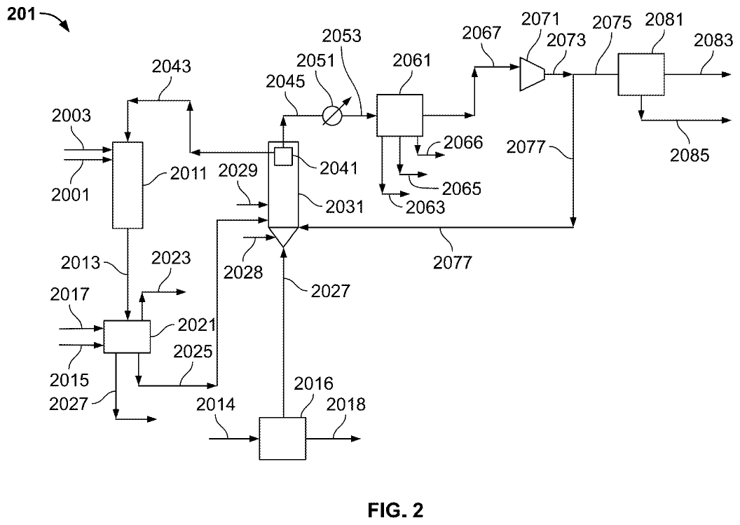

FIG. 2 depicts another illustrative system 201 for converting a hydrocarbon-containing feed in line 2001 by pyrolysis and primarily combustion, according to one or more embodiments. The system 201 can include one or more pyrolysis zones 2011, one or more air separation stages 2016, one or more first separation stages 2021, one or more gasification/combustion zones 2031, one or more second separation stages 2041, one or more heat exchange stages 2051, and one or more third separation stages 2061. The system 101 can also include one or more compression stages 2071 and one or more fourth separation stages 2081. The hydrocarbon-containing feed via line 2001 and heated particles via line 2043 can be fed into the pyrolysis zone 2011. In some embodiments, an optional steam stream via line 2003 can also be fed into the pyrolysis zone 2011. In some embodiments, if the optional steam stream via line 2003 is introduced into the pyrolysis zone 2011, the optional steam stream can be introduced upstream of the hydrocarbon-containing feed.

The hydrocarbon-containing feed and optionally the steam stream can contact the heated particles within the pyrolysis zone 2011 to effect pyrolysis of at least a portion of the hydrocarbons in the hydrocarbon-containing feed to produce a pyrolysis zone effluent. The pyrolysis zone effluent can include olefins and particles having coke deposited or otherwise formed on a surface thereof. The pyrolysis zone effluent via line 2013 can be obtained from the pyrolysis zone 2011 and fed into the first separation stage 2021. Optionally a stripping steam stream via line 2015 can be introduced into the second separation stage 2021 to improve the separation of gaseous components that can be entrained in the particles.

A first gaseous stream rich in the olefins via line 2023 and a second particle stream rich in the particles via line 2025 can be discharged or otherwise obtained from the second separation stage 2021. In some embodiments, a portion of the particles from the pyrolysis zone effluent can be recovered via line 2027 from the second separation stage 2021 and removed from the system 101. In some embodiments, it can be desirable to remove some of the particles via line 2027 and replace the removed particles with fresh or make-up particles via line 2017. For example, should the particles accumulate too much of a transition metal on the surface thereof, some of the particles can be removed via line 2027 while make-up particles can be introduced via line 2017 into the system 101.

The second particle stream via line 2025, an oxidant stream via line 2027, an optional steam stream via line 2028, an optional fuel stream via line 2029, and/or an optional diluent stream via line 2077 can be introduced or otherwise fed into the gasification/combustion zone 2031. In some embodiments, the oxidant stream in line 2027 can be recovered or otherwise obtained from the air separation unit 2016. More particularly, an air stream via line 2014 can be introduced or otherwise fed into the air separation stage 2016 and the oxidant stream via line 2027 and a nitrogen rich stream via line 2018 can be discharged or otherwise obtained from the air separation stage 2016. The air separation stage 2016 can be or can include, but is not limited to, a cryogenic air separation unit, a membrane separation unit, a pressure swing adsorption unit, a vacuum pressure swing adsorption unit, and/or any other device or system capable of separating oxygen and nitrogen from air. In some embodiments, the oxidant in line 2027 can include molecular oxygen at a concentration of ≥95 vol % and molecular nitrogen at a concentration of ≤5 vol %, based on the total volume of the oxidant stream.

The particles having the coke formed on the surface thereof, oxidant, optional steam, optional fuel, and/or optional diluent can be contacted within the gasification/combustion zone 2031 to effect gasification and/or combustion of at least a portion of the coke disposed on the surface of the particles to produce a gasification/combustion zone effluent. The gasification/combustion zone effluent can include heated and regenerated particles and a gasification/combustion gas mixture that can include a flue gas that can include molecular nitrogen, carbon dioxide, and water.

In some embodiments, the gasification/combustion zone effluent can be fed into the second separation stage 2041 and a third particle stream that can include the heated and regenerated particles via line 2043 and a second gaseous stream rich in the gasification/combustion gas mixture via line 2045 can be recovered or otherwise obtained therefrom. The second separation stage 2041, as shown, can be disposed within the gasification/combustion zone 2031. However, the second separation stage 2041 can also be located outside the gasification/combustion zone 2031. The third separation stage 2031 can be an inertial separator or other separator as described above. In some embodiments, at least a portion of the third particle stream via line 2043 can be fed into the pyrolysis zone 2011 as at least a portion of the heated particles introduced thereto.

In some embodiments, the second gaseous stream via line 2045 can be introduced into the heat exchange stage 2051 to produce a cooled or quenched second gaseous stream via line 2053. The cooled second gaseous stream in line 2053 can be rich in the gasification/combustion zone mixture and can include condensed or liquid water. The second gaseous stream in line 2045 can be indirectly cooled by transferring heat from the second gaseous stream to a cooling medium, by direct contact with a cooling medium, or a combination thereof. In some embodiments, particles entrained in the second gaseous stream in line 2045 can also be present in the condensed water. The cooled second gaseous stream via line 2053 can be introduced or otherwise fed into the third separation stage 2061 to separate a portion of the condensed water and, if present, a portion of the particles via line 2063.

The third separation stage 2061 can include multiple separation stages. In some embodiments, the third separation stage 2061, in addition to removing the water and, if present, particles, can also include one or more sulfur oxides (SOx), e.g., SO₂, removal stage. As such, SOx, if present, can also be removed via line 2065 from the cooled second gaseous stream in the third separation stage 2061. Processes and systems for removing SOx are well-known and can include those described in U.S. Pat. Nos. 3,873,670; 4,001,375; 4,071,436; 4,059,418; 4,254,616; 5,120,517; 5,741,469; 5,728,358; and WO Publication No. 2009/017811.

In some embodiments, the third separation stage 2061, in addition to removing the water and, if present, particles, can also include a nitrogen oxide (NOx) removal stage. As such, nitrogen oxides, if present, can also be removed via line 2066 as a mixture that can include molecular nitrogen and water. Processes and systems for removing NOx are well-known and can include those described in U.S. Pat. Nos. 3,900,554; 4,104,361; 4,164,546; 4,235,704; and 4,254,616. A purified second gaseous steam via line 2067 can be recovered or otherwise obtained from the third separation stage 2061.

In some embodiments, the purified second gaseous stream via line 2067 can be introduced or otherwise fed into the compression stage 2071 to produce a compressed second gaseous stream via line 2073. In some embodiments, all or a portion of the compressed second gaseous stream in line 2073 can be introduced via line 2075 into the fourth separation stage 2081. In some embodiments, a portion of the compressed second gaseous stream in line 2073 can be introduced or otherwise fed via line 2077 to the gasification/combustion zone 2031 as the optional diluent stream.

It should be understood that while a portion of the water can be separated from the cooled second gaseous stream within the third separation stage 2061, not all water can be removed. As such, the compressed second gaseous stream fed via line 2075 into the fourth separation stage 2081 can include water. As such, the fourth separation stage 2081 can be configured to separate at least a portion of the water to produce a dried carbon dioxide-rich stream. As discussed above, the compressed second gaseous stream in line 2075 can be subjected to dehydration to produce a carbon dioxide-rich stream that can include, on a dry basis, carbon dioxide at a concentration of ≥90 vol %, ≥93 vol %, ≥95 vol %, ≥97 vol %, or ≥99 vol %, based on the total volume of the carbon dioxide-rich stream. The dehydration of the compressed second gaseous stream can be carried out using any convenient system. In some embodiments, the dehydration of the compressed second gaseous stream can be carried out according to the processes and systems disclosed in U.S. Patent Application Publication No. 2012/0060690.

The carbon dioxide-rich stream via line 2083 can be utilized, upon optional compression, in an enhanced oil recovery process; sequestered, e.g., in a subterranean formation; converted into another compound; and/or introduced into a carbon dioxide pipeline.

The water separated or otherwise removed from the compressed second gaseous stream can be removed via line 2085 from the system 101.

### Listing of Embodiments

This disclosure may further include the following non-limiting embodiments.

A1. A process for converting a hydrocarbon-containing feed by pyrolysis, the process comprising: (I) feeding the hydrocarbon-containing feed and heated particles into a pyrolysis zone; (II) contacting the hydrocarbon-containing feed with the heated particles in the pyrolysis zone to effect pyrolysis of at least a portion of the hydrocarbon-containing feed to produce a pyrolysis zone effluent comprising olefins and the particles, wherein coke is formed on the surface of the particles; (III) obtaining from the pyrolysis zone effluent a first gaseous stream rich in the olefins and a first particle stream rich in the particles; (IV) feeding at least a portion of the first particle stream, an oxidant stream, and an optional steam stream into a gasification/combustion zone, wherein the oxidant stream comprises molecular oxygen; (V) contacting the first particle stream, the oxidant stream, and the optional steam stream within the gasification/combustion zone to effect gasification/combustion of at least a portion of the coke disposed on the surface of the particles to produce a gasification/combustion zone effluent comprising regenerated particles and a gasification/combustion gas mixture comprising CO and/or CO₂; (VI) obtaining from the gasification/combustion zone effluent a second gaseous stream rich in the gasification/combustion gas mixture and a second particle stream rich in the regenerated particles; (VII) feeding at least a portion of the second particle stream into the pyrolysis zone as at least a portion of the heated particles fed into the pyrolysis zone in step (I); and (VIII) obtaining a CO₂-rich stream from the gasification/combustion gas mixture, wherein the CO₂-rich stream, on a dry basis, comprises CO₂ at a concentration of ≥90 vol %, based on the total volume of the CO₂-rich stream.

A2. The process of A1, wherein the oxidant stream comprises N₂ at a concentration ≥15 vol %, based on the total volume of the oxidant stream, the gasification/combustion zone is a gasification zone, the second gaseous mixture comprises H₂, CO, CO₂, and N₂, and step (VIII) comprises: (VIIIa) reacting at least a portion of the second gaseous steam with additional steam under shifting conditions to produce a shifted gas stream, where the shifted gas stream, on a dry basis, comprises CO₂ at a concentration of ≥20 vol %, based on the total volume of the shifted gas stream; and (VIIIb) obtaining from the shifted gas stream the CO₂-rich stream and a CO₂-lean gas stream comprising H₂ and N₂.

A3. The process of A2, further comprising combusting at least a portion of the CO₂-lean gas stream to produce heat.

A4. The process of A2 or A3, further comprising: (IX) combining a fuel with the CO₂-lean gas stream to produce an adjusted gas stream; and (X) combusting at least a portion of the adjusted gas stream to produce heat.

A5. The process of A4, wherein the fuel comprises methane, ethane, propane, butane, or a mixture thereof.

A6. The process of any of the preceding A2 to A5, wherein step (IV) further comprises feeding a diluent stream into the gasification zone, and wherein the diluent stream comprises a portion of the second gaseous stream obtained in step (VI).

A7. The process of any of the preceding A2 to A6, wherein step (VIIIa) comprises: (VIIIa-1) indirectly transferring heat from the second gaseous stream to a cooling medium to produce a cooled second gaseous stream comprising water; (VIIIa-2) separating at least a portion of the water produced in step (VIIIa-1); (VIIIa-3) optionally separating at least one of: (i) at least a portion of any regenerated particles, if present in the second gaseous stream; and (ii) at least a portion of any hydrogen sulfide from the cooled second gaseous stream, if present in the second gaseous stream, to produce a purified second gaseous stream; (VIIIa-4) compressing at least a portion of the purified second gaseous stream to produce a compressed second gaseous stream; and (VIIIa-5) mixing at least a portion of the compressed second gaseous stream with the additional steam to effect the reacting under the shifting conditions to produce the shifted gas stream.

A8. The process of A7, wherein step (IV) further comprises feeding a diluent stream into the gasification zone, and wherein the diluent stream comprises a portion of the compressed second gaseous stream obtained in step (VIIIa-4).

A9. The process of any of A2 to A8, wherein step (IV) further comprises feeding a hydrocarbon fuel stream into the gasification/combustion zone, wherein a first portion of the hydrocarbon fuel stream is combusted within the gasification zone, and wherein a second portion of the hydrocarbon fuel stream is converted into H₂ and CO.

A10. The process of any of A2 to A9, wherein, on a volume basis, the second gaseous stream comprises a greater amount of N₂ than a combined amount of H₂, CO, and CO₂.

A11. The process of any of A2 to A10, wherein the second gaseous stream comprises, based on the total volume of the second gaseous stream: H₂ at a concentration from 10 vol % to vol %; CO at a concentration from 15 vol % to 30 vol %; and CO₂ at a concentration of ≥3 vol %.

A12. The process of A1, wherein the oxidant stream comprises O₂ at a concentration ≥95 vol % and N₂ at a concentration ≤5 vol %, based on the total volume of the oxidant stream, the gasification/combustion zone is a combustion zone, the second gaseous mixture is a flue gas comprising CO₂ and H₂O, and step (VIII) comprises: (VIIIc) indirectly transferring heat from the second gaseous stream to a cooling medium to produce a cooled second gaseous stream comprising water; and (VIIId) separating at least a portion of the water from the cooled second gaseous stream to produce the CO₂-rich stream comprising, on a dry basis, CO₂ at a concentration ≥90 vol % CO₂, based on the total volume of the CO₂-rich stream.

A13. The process of A12, wherein step (VIII) further comprises at least one of the following: (VIIIe) abating at least a portion of fine particles, if any, from the second gaseous stream; (VIIIf) abating at least a portion of SO₂, if any, from the second gaseous stream; and (VIIIg) abating at least a portion of NOx, if any, from the second gaseous stream.

A14. The process of any of the preceding A1 to A13, further comprising at least one of the following: utilizing the CO₂-rich stream, upon optional compressing, in an enhanced oil recovery process; sequestering the CO₂-rich stream; converting at least a portion of the CO₂-rich stream into another compound; and introducing the CO₂-rich stream into a CO₂ pipeline.

A15. The process of any of the preceding A1 to A14, further comprising feeding a steam stream into the pyrolysis zone in step (I).

A16. The process of A15, wherein the following is met: (i) a weight ratio of the steam stream to the hydrocarbon-containing feed fed into the pyrolysis zone is 0.01:1 to 6:1.

A17. The process of any of the preceding A1 to A16, wherein the following is met: (ii) a velocity of gaseous components within the pyrolysis zone is at least 20% greater than a velocity of the particles within the pyrolysis zone.

A18. The process of any of the preceding A1 to A17, wherein the following is met: (iii) the pyrolysis zone is operated at a temperature of 800° C. to 1,100° C.

A19. The process of any of the preceding A1 to A18, wherein the following is met: (iv) a pressure within the pyrolysis zone is from 100 kPa-absolute to 7,000 kPa-absolute.

A20. The process of any of the preceding A1 to A19, wherein the following is met: (v) a velocity of the gaseous components within the pyrolysis zone is in a range of 9 m/s to 155 m/s.

A21. The process of any of the preceding A1 to A20, wherein the following is met: (vi) a velocity of the particles within the pyrolysis zone is up to 15.5 m/s.

A22. The process of any of the preceding A1 to A21, wherein the following is met: (vii) a weight ratio of the particles to the hydrocarbon-containing feed stream fed into the pyrolysis zone in step (I) is 7:1 to 35:1.

A23. The process of any of the preceding A1 to A22, wherein the following is met: (viii) the hydrocarbon-containing feed is contacted with the heated particles within the pyrolysis zone for a gas residence time of 10 milliseconds to 700 milliseconds, preferably in a downflow reactor.

A24. The process of any of the preceding A1 to A23, wherein the heated particles in step (I) comprise: silica, alumina, titania, zirconia, magnesia, pumice, ash, clay, diatomaceous earth, bauxite, spent fluidized catalytic cracker catalyst, or a mixture thereof.

A25. The process of any of the preceding A1 to A24, wherein the gasification/combustion zone is operated at a temperature of at least 1,000° C. such as 1,200° C. to 1,500° C., and at a pressure of ≤800 kPa-absolute.

A26. The process of any of the preceding A1 to A25, wherein the gasification/combustion zone is operated at a temperature of at least 1,000° C. such as 1,200° C. to 1,500° C., and at a pressure of ≥800 kPa-absolute such as 800 kPa-absolute to 7,000 kPa-absolute.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

We claim:

1. A process for converting a hydrocarbon-containing feed by pyrolysis, the process comprising:
(I) feeding the hydrocarbon-containing feed and heated particles into a pyrolysis zone;
(H) contacting the hydrocarbon-containing feed with the heated particles in the pyrolysis zone to effect pyrolysis of at least a portion of the hydrocarbon-containing feed to produce a pyrolysis zone effluent comprising olefins and the particles, wherein coke is formed on the surface of the particles;
(III) obtaining from the pyrolysis zone effluent a first gaseous stream rich in the olefins and a first particle stream rich in the particles;
(IV) feeding at least a portion of the first particle stream, an oxidant stream, and an optional steam stream into a gasification/combustion zone, wherein the oxidant stream comprises molecular oxygen;
(V) contacting the first particle stream, the oxidant stream, and the optional steam stream within the gasification/combustion zone to effect gasification/combustion of at least a portion of the coke disposed on the surface of the particles to produce a gasification/combustion zone effluent comprising regenerated particles and a gasification/combustion gas mixture comprising CO and/or CO₂;
(VI) obtaining from the gasification/combustion zone effluent a second gaseous stream rich in the gasification/combustion gas mixture and a second particle stream rich in the regenerated particles;
(VII) feeding at least a portion of the second particle stream into the pyrolysis zone as at least a portion of the heated particles fed into the pyrolysis zone in step (I); and
(VIII) obtaining a CO₂-rich stream from the gasification/combustion gas mixture, wherein the CO₂-rich stream, on a dry basis, comprises CO₂ at a concentration of ≥90 vol %, based on the total volume of the CO₂-rich stream.

2. The process of claim 1, wherein the oxidant stream comprises N₂ at a concentration ≥15 vol %, based on the total volume of the oxidant stream, the gasification/combustion zone is a gasification zone, the second gaseous mixture comprises H₂, CO, CO₂, and N₂, and step (VIII) comprises:
(Villa) reacting at least a portion of the second gaseous steam with additional steam under shifting conditions to produce a shifted gas stream, where the shifted gas stream, on a dry basis, comprises CO₂ at a concentration of 20 vol %, based on the total volume of the shifted gas stream; and
(VIIIb) obtaining from the shifted gas stream the CO₂-rich stream and a CO₂-lean gas stream comprising H₂ and N₂.

3. The process of claim 2, further comprising combusting at least a portion of the CO₂-lean gas stream to produce heat.

4. The process of claim 2, further comprising:
(IX) combining a fuel with the CO₂-lean gas stream to produce an adjusted gas stream; and
(X) combusting at least a portion of the adjusted gas stream to produce heat.

5. The process of claim 4, wherein the fuel comprises methane, ethane, propane, butane, or a mixture thereof.

6. The process 2, wherein step (IV) further comprises feeding a diluent stream into the gasification zone, and wherein the diluent stream comprises a portion of the second gaseous stream obtained in step (VI).

7. The process of claim 2, wherein step (Villa) comprises:
(VIIIa-1) indirectly transferring heat from the second gaseous stream to a cooling medium to produce a cooled second gaseous stream comprising water;
(Villa-2) separating at least a portion of the water produced in step (Villa-1);
(VIIIa-3) optionally separating at least one of: (i) at least a portion of any regenerated particles, if present in the second gaseous stream; and (ii) at least a portion of any hydrogen sulfide from the cooled second gaseous stream, if present in the second gaseous stream, to produce a purified second gaseous stream;
(VIIIa-4) compressing at least a portion of the purified second gaseous stream to produce a compressed second gaseous stream; and
(Villa-5) mixing at least a portion of the compressed second gaseous stream with the additional steam to effect the reacting under the shifting conditions to produce the shifted gas stream.

8. The process of claim 7, wherein step (IV) further comprises feeding a diluent stream into the gasification zone, and wherein the diluent stream comprises a portion of the compressed second gaseous stream obtained in step (VIIIa-4).

9. The process of claim 2 wherein step (IV) further comprises feeding a fuel stream into the gasification/combustion zone, wherein a first portion of the fuel stream is combusted within the gasification zone, and wherein a second portion of the fuel stream is converted into H₂ and CO.

10. The process of claim 2, wherein, on a volume basis, the second gaseous stream comprises a greater amount of N₂ than a combined amount of CO, and CO₂.

11. The process of claim 2, wherein the second gaseous stream comprises, based on the total volume of the second gaseous stream:
H₂ at a concentration from 10 vol % to 25 vol %;
CO at a concentration from 15 vol % to 30 vol %; and
CO₂ at a concentration of ≥3 vol %.

12. The process of claim 1, wherein the oxidant stream comprises 02 at a concentration ≥95 vol % and N₂ at a concentration ≤5 vol %, based on the total volume of the oxidant stream, the gasification/combustion zone is a combustion zone, the second gaseous mixture is a flue gas comprising CO₂ and H₂O, and step (VIII) comprises:
(VIIIc) indirectly transferring heat from the second gaseous stream to a cooling medium to produce a cooled second gaseous stream comprising water; and
(VIIId) separating at least a portion of the water from the cooled second gaseous stream to produce the CO₂-rich stream comprising, on a dry basis, CO₂ at a concentration ≥90 vol % CO₂, based on the total volume of the CO₂-rich stream.

13. The process of claim 12, wherein step (VIII) further comprises at least one of the following:
(VIIIe) abating at least a portion of fine particles, if any, from the second gaseous stream;
(VIIIf) abating at least a portion of SO₂, if any, from the second gaseous stream; and
(VIIIg) abating at least a portion of NOx, if any, from the second gaseous stream.

14. The process of claim 2, further comprising at least one of the following:
utilizing the CO₂-rich stream, upon optional compressing, in an enhanced oil recovery process;
sequestering the CO₂-rich stream;
converting at least a portion of the CO₂-rich stream into another compound; and
introducing the Ca-rich stream into a CO₂ pipeline.

15. The process of claim 2, further comprising feeding a steam stream into the pyrolysis zone in step (I), wherein at least one of the following is met:
(i) a weight ratio of the steam stream to the hydrocarbon-containing feed fed into the pyrolysis zone is 0.01:1 to 6:1;
(ii) a velocity of gaseous components within the pyrolysis zone is at least 20% greater than a velocity of the particles within the pyrolysis zone;
(iii) the pyrolysis zone is operated at a temperature of 800° C. to 1,100° C.;
(iv) a pressure within the pyrolysis zone is from 100 kPa-absolute to 7,000 kPa-absolute;
(v) a velocity of the gaseous components within the pyrolysis zone is in a range of 9 m/s to 155 m/s;
(vi) a velocity of the particles within the pyrolysis zone is up to 15.5 m/s;
(vii) a weight ratio of the particles to the hydrocarbon-containing feed stream fed into the pyrolysis zone in step (I) is 7:1 to 35:1; and
(viii) the hydrocarbon-containing feed is contacted with the heated particles within the pyrolysis zone for a gas residence time of 10 milliseconds to 700 milliseconds, preferably in a downflow reactor.

16. The process of claim 1, wherein the heated particles in step (I) comprise:
silica, alumina, titania, zirconia, magnesia, pumice, ash, clay, diatomaceous earth, bauxite, spent fluidized catalytic cracker catalyst, or a mixture thereof.

17. The process of claim 1 wherein the gasification/combustion zone is operated at a temperature of at least 1,000° C. such as 1,200° C. to 1,500° C., and at a pressure of ≤800 kPa-absolute.

18. The process of claim 1, wherein the gasification/combustion zone is operated at a temperature of at least 1,000° C. such as 1,200° C. to 1,500° C., and at a pressure of ≥800 kPa-absolute such as 800 kPa-absolute to 7,000 kPa-absolute.
